(19) United States
(12) Patent Application Publication
(10) Pub. No.: US 2003/0016830 A1
(43) Pub. Date: Jan. 23, 2003

(54) Speaker system

(76) Inventor: Niro Nakamichi, Tokyo (JP)

Correspondence Address: DARBY & DARBY P.C., P. O. BOX 5257, NEW YORK, NY, 10150-5257, US

(21) Appl. No.: 10/095,309

(22) Filed: Mar. 11, 2002

(30) Foreign Application Priority Data
Jul. 23, 2001 (JP) 2001-220932

(51) Int. Cl. H04R 5/00; H04R 5/02

(52) U.S. Cl. 381/18

(57) ABSTRACT

The present invention includes: a front L-channel speaker unit for outputting a front L-minus-R signal; a front R-channel speaker unit for outputting a front R-minus-L signal; a front center speaker unit for outputting a front center signal consisting of front R-plus-front L; a rear L-channel speaker unit for outputting a rear L-minus-R signal; a rear R-channel speaker unit for outputting a rear R-minus-L signal; and a rear center speaker unit for outputting a rear L-plus-R signal. The subtracted signals contain only frequency components below a predetermined frequency.

### BACKGROUND OF THE INVENTION

The present invention relates to a speaker system for playing back multi-channel signals, e.g., Dolby digital signals.

Playback of multi-channel signals, such as Dolby digital signals, generally requires a speaker for each channel In the case of a Dolby digital system, for example, a total of six channels are played back: an L channel, an R channel, a center channel for the front, a surround L channel and a surround R channel for the rear, and a subwoofer channel for low frequencies. Thus, six speakers must be used.

A speaker cable must be laid from the amp to each of these speakers. For hi-fi playback, these speaker cables must be as short as possible. Laying of six cables laid across the floor can damage the appearance of the room and can prevent the speakers from being placed in appropriate places.

### OBJECT AND SUMMARY OF THE INVENTION

An object of the present invention is to overcome the problem described above.

The present invention includes: a front L-channel speaker unit outputting a signal in which the front R-channel signal is subtracted from the front L-channel signal; a front R-channel speaker unit outputting a signal in which the front L-channel signal is subtracted from the front R-channel signal; a front center speaker unit outputting the front center signal; a front enclosure equipped with the front L-channel speaker unit, the front R-channel speaker unit, and the front center speaker unit; a rear L-channel speaker unit outputting a signal in which the rear R-channel signal is subtracted from the rear L-channel signal; a rear R-channel speaker unit outputting a signal in which the rear L-channel signal is subtracted from the rear R-channel signal; a rear center speaker unit outputting a signal in which the rear L-channel signal is added to the rear R-channel signal; and a rear enclosure equipped with the rear L-channel speaker unit, the rear R-channel speaker unit, and the rear center speaker unit.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a plan drawing of a front enclosure.

FIG. 2 is a right-side drawing of a front enclosure.

FIG. 3 is a plan drawing of a rear enclosure.

FIG. 4 is a front-view drawing of a rear enclosure.

FIG. 5 is a plan drawing showing the front and rear enclosures installed in a room.

FIG. 6 is a block diagram of a signal processing device.

### DETAILED DESCRIPTION OF THE PREFERRED EMBODIMENTS

In a Dolby digital system, which is one type of multi-channel surround-sound system, speakers must be provided for a total of six channels: three channels in the front (a L channel, a R channel and a center channel), two channels in the rear (a rear L channel and a rear R channel), and one subwoofer channel.

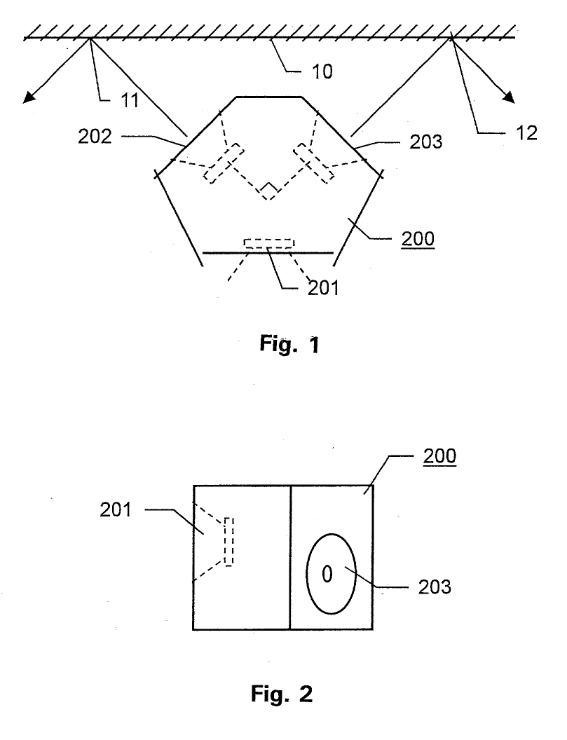

Referring to FIG. 1 and FIG. 2, an enclosure 200 is positioned in front of the listener. A center speaker unit 201 is disposed in the front center of enclosure, facing the listener. The center speaker unit 201 receives what is essentially a mono signal The mono signal may be the L+R component of the recorded sound or some other mono source. On the left side of enclosure 200, an L-channel speaker unit 202 faces diagonally in the left rear direction from the center speaker unit 201. The L-channel speaker unit 202 receives the L-minus-R component (L−R). On the right side, an R-channel speaker unit 203 similarly faces diagonally in the right rear direction. The R-channel speaker unit 203 receives the R-minus-L component (R−L). This design assumes the presence of a wall 10 behind the enclosure 200. The sound from the L- and R-speaker units 202, 203 radiate diagonally at approximately 45 degrees toward the wall 10. Thus, the vibration axes of the speaker units 202, 203 form an angle of approximately 90 degrees.

When the L−R and R−L signals are subtracted, the in-phase portions of these signals are cancelled, while the out-of-phase components are preserved. Such out-of-phase components, when reproduced in the manner disclosed herein, expands the stereo image. Low-pass filtering removes frequency components above about 2 kHz from the L and R signals before the subtraction. Removal is required because the removed high-frequency signals would otherwise produce noise, without contributing to the stereo image.

Expanding the stereo image in this way is disclosed in U.S. Pat. Nos. 4,819,269 and 5,610,986, the disclosures of which are hereby incorporated by reference.

As a result, the speaker unit 202 has a virtual position at a reflection point 11 where the sound from the speaker unit 202 reflects off the wall 10. The speaker unit 203 has a virtual position at a reflection position 12 where the sound from the speaker unit 203 reflects off of the wall 10. Thus, even though the speaker units 203, 203 are placed compactly within the single enclosure 200, the speaker units 202, 203 are perceived as being spaced far apart, thus providing a wider stereo image.

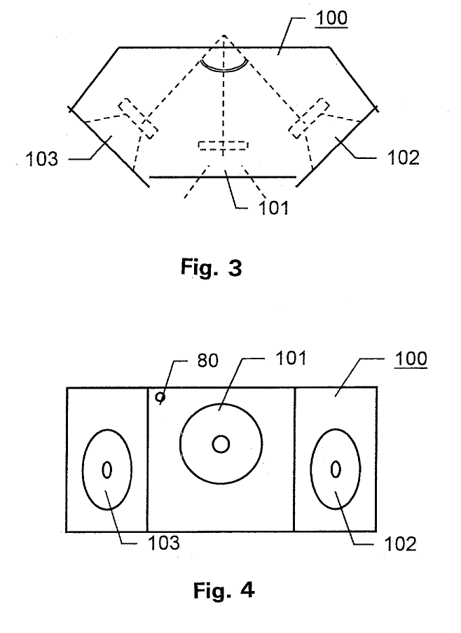

The attachment height of the center speaker unit 201 is higher the attachment height of the L-channel speaker unit 202 and the R-channel speaker unit 203. Thus, the output source for the positive-phase component from the speaker unit 201 and the negative-phase component from the speaker unit 202 are perceived as being positioned at distinctly different heights, resulting in improved localization of sound. Elevating the center speaker unit 201 provides superior sound quality. Referring to FIGS. 3 and 4, a rear enclosure 100 includes center speaker unit 101 is disposed on the front of the enclosure 100 to play back the sum of the rear L-channel and the rear R-channel An L-channel speaker unit 102 plays back the L−R component in which the rear R-channel is subtracted from the rear L-channel. A rear R-channel speaker unit 103 plays back the R−L component in which the rear L-channel is subtracted from the rear R-channel.

The L-channel and R-channel speaker units 102, 103 are oriented outward to form an angle of approximately 50 degree angles relative to the center speaker unit 101. As with the front enclosure 200, the L-channel and R-channel speaker units 102, 103 are placed at a different height from the speaker unit 101 to provide improved spatial definition in the sound.

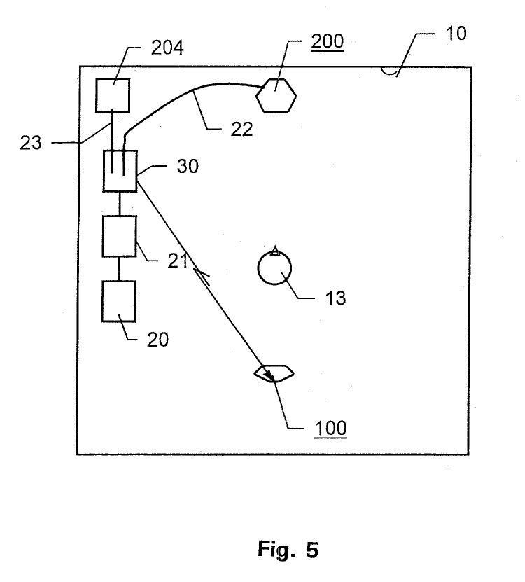

Referring to FIG. 5, the enclosure 200 is placed in front of a listener 13 and an enclosure 100 is placed behind the listener. A DVD player 20 and an A/V amp 21 are connected by an optical cable. When a DVD is loaded in the DVD player 20, the video signal and the undecoded 5.1-channel audio signal are sent to the A/V amp 21. The AN amp 21 decodes the audio signal from the DVD player 20 and converts the signal to a 5.1-channel audio signal This is then output to a signal processing device 30. Audio from a CD in the DVD player 20, is sent as a two-channel audio signal to the AN amp 21.

The signal processing device 30 is connected by cables 22, 23 to the front enclosure 200 and the subwoofer 204 respectively. The signal processing device 30 is connected to the rear enclosure via an infrared signal. Thus, by connecting the signal processing device 30 to the enclosure 200 with a six-line cable, a single cable is sufficient to connect the signal processing device 30 and the front speaker device 200. Since the rear enclosure 100 is connected via an infrared signal, no cable is required. As a result, the amount of speaker cable used is much less than if the speakers were mounted in the corner of the room, and the look of the room is not affected negatively. Also, since a 5.1-channel system can be set up with the front enclosure 200, the rear enclosure 100, and the subwoofer 204, fewer speaker units need to be installed.

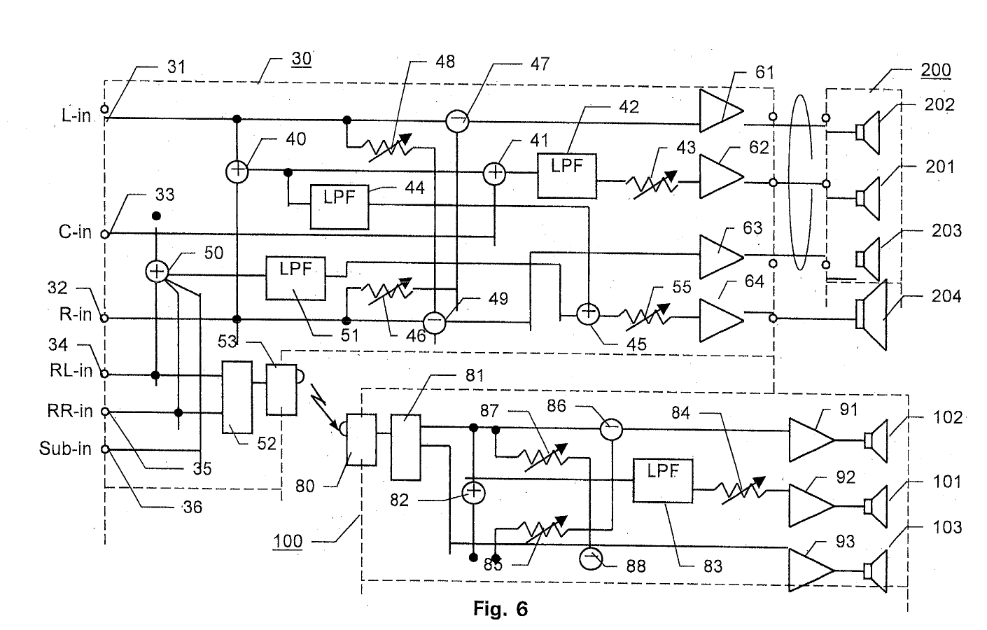

Referring to FIG. 6, there is shown a block diagram of the signal processing device 30. L-channel signals from stereo output signals such as CD players and tuners are sent to an L-in terminal 31, and R-channel signals are sent to an R-in terminal 32. The two signals are added using an adder 40 to form an L+R signal, which then goes through an adder 41 and a low-pass filter 42 (hereinafter referred to as LPF). The LPF 42 removes high frequencies above approximately 2 kHz. The signal then goes through a variable resister 43 for gain adjustment and then to an amplifier 62 and is output through the center speaker 201.

The signal also goes through a low-pass filter (LPF) 44 which removes frequencies above approximately 150 Hz from the L+R signal The resulting low-frequency signal passes through an adder 45 and is amplified by an amplifier 64. This signal is output from the subwoofer 204.

The R-channel signal is level-adjusted with a variable resister 46 and subtracted from the L-channel signal received from the L-in terminal 31 by a subtracter 47, resulting in an L−R signal. This is then amplified by an amplifier 61 and is output from the L-channel speaker 202. Similarly, the L-channel signal is level-adjusted with a variable resister 48 and subtracted from the R-channel signal from the R-in terminal 32 by a subtracter 49, resulting in an R−L signal This is then amplified by an amplifier 63 and is output through the R-channel speaker 203.

Thus, the L−R signal is output from the speaker 202, the low- and mid-range components of the L+R signal are output from the speaker 201, the R−L signal is output from the speaker 203, and the low-range component of the L+R signal is output from the subwoofer 204. As a result of the signal processing described above, a negative R-channel signal is added to the L-channel signal, and a negative L-channel signal is added to the R-channel signal. This provides a broad sound field space even though the speakers may be close together.

Also, since high-frequency components have a significant effect on sound image localization, the LPF 42 is used to prevent the high-frequency components of the L+R signal from being output from the center speaker 201.

By placing the enclosure 200 close to the wall 10, the L−R signal and the R−L signal travel toward the listener after being reflected by the wall 10 as indicated by the arrows in FIG. 1. Thus, the sound image is dispersed over a wider range, and a broader stereo image results.

The above description presents circuit operations performed when playing two-channel audio signals. This device can also receive Dolby digital 5.1-channel signals as well. In this case, in addition to the L-in terminal 31 and the R-in terminal 32 described above, the output signal from an A/V amp 71 is also sent as follows: a front center-channel signal is sent to a C-in terminal 33; a rear L-channel signal is sent to a RL-In terminal 34; a rear R-channel signal is sent to an RR-In terminal 35; and a subwoofer signal is sent to a Sub-in terminal 36.

The C-in terminal 33 is connected to the adder 41 so that the center-channel signal from the Dolby digital signal is added to the L+R signal described above. The high-frequency components are then removed by the LPF 42, and the resulting signal is output from the center speaker unit 201. The C-in terminal 33, the RL-in terminal 34, the RR-in terminal 35, and the Sub-in terminal 36 are connected to an adder 50 so that the rear L-channel signal, the rear R-channel signal, and the subwoofer signal are added. An LPF 51 extracts the low-frequency signals of approximately 150 Hz or lower from this added signal. The adder 45 then adds the low-frequency components of the front L-channel signal, the front R-channel signal. The resulting signal is passed through the variable resister 55 for gain adjustment and then sent to an amplifier 64.

Thus, in addition to the signal sent to the subwoofer input terminal 35, the subwoofer 204 outputs the low-frequency components from all channels. This allows the subwoofer 204 to output the low-frequency components that cannot be played back by the small apertures of the speaker units in the speaker devices 100, 200, thus preventing inferior output of low frequencies, which can affect realism This takes advantage of the fact that humans cannot identify the directionality of low frequency components. For example, if a low-frequency component is present only in the rear L-channel, the listener will not be able to recognize that low frequencies are being output from the rear left. Thus, there is no problem with using the subwoofer to output low frequencies that should be coming from the rear left side.

The rear L-channel signal and the rear R-channel signal from the RL-in terminal 34 and the RR-in terminal 35 are converted to serial signals by a signal converter 52. The result is then output via an infrared connection from a light-emitting device 53. A light-receiving device 80 disposed in the rear speaker device 100 receives this infrared signal which is then demodulated into a two-channel signal by a signal converter 81. The demodulated rear L-channel signal and the rear R-channel signal are added by an adder 82. High-frequency components are removed with an LPF 83. The resulting signal is passed through a variable resister 84 for gain adjustment and amplified by an amplifier 92. This is then output from the center speaker unit 101.

Also, the rear R-channel signal is adjusted to a prescribed level by a variable resister 85 for gain adjustment. The result is subtracted from the rear L-channel signal by a subtracter 86 to form the rear-channel L−R signal. This L−R signal is amplified by an amplifier 91 and output through the speaker unit 102. Similarly, the rear L-channel signal is set to a prescribed level by a variable resister 87 for gain adjustment. The result is subtracted from the rear R-channel signal by a subtracter 88 to form a rear-channel R−L signal. This R−L signal is amplified by an amplifier 93 and is output from the speaker unit 103.

As in the front speakers, the L-channel speaker 102 outputs a negative-phase component of the R-channel signal, and the R-channel speaker 103 outputs a negative-phase component of the L-channel signal. Thus, as in the speaker device 200, the sound image is dispersed over a wider range even if the speaker units 102, 103 are close together, thus providing a broader stereo image.

In the embodiment described above, an infrared connection is used to transfer the playback signal to the rear enclosure. The present invention is not restricted to this. A speaker cable, RF link, or other signal transmission technique can be used to transfer the signal, without departing from the spirit and scope of the invention.

Also, in the embodiment described above, a gain-adjusted R signal is subtracted from the L-channel signal to generate the L−R signal However, depending on the speaker units and the environment of the room in which the units are used, it would also be possible to perform signal subtraction and addition that takes frequency characteristics into account. For example, the mid-range signal of the R channel can be subtracted from the L-channel signal to generate the L−R signal

Also, in the embodiment described above, the L, R speaker units 202, 203 face away from the center speaker unit 201. However, it would also be possible to face these speakers in the same direction as the center speaker unit 201 so that the output is projected directly to the listener.

As described above, a speaker system that requires three speakers in the front and two speakers in the rear can be set up with a total of two units. Thus, a multi-channel playback system can be set up easily so that less space is required for installing speakers, and the appearance of the listening room is not affected negatively.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A speaker system for outputting at least a front L-channel signal, a front R-channel signal, a front center-channel signal, a rear L-channel signal, and a rear R-channel signal, comprising:
a front L-channel speaker unit outputting a signal in which said front R-channel signal is subtracted from said front L-channel signal;
a front R-channel speaker unit outputting a signal in which said front L-channel signal is subtracted from said front R-channel signal;
a front center speaker unit outputting at least said front center channel signal;
a front enclosure equipped with said front L-channel speaker unit, said front R-channel speaker unit, and said front center speaker unit;
a rear L-channel speaker unit outputting a signal in which said rear R-channel signal is subtracted from said rear L-channel signal;
a rear R-channel speaker unit outputting a signal in which said rear L-channel signal is subtracted from said rear R-channel signal;
a rear center speaker unit outputting a signal in which said rear L-channel signal is added to said rear R-channel signal; and
a rear enclosure equipped with said rear L-channel speaker unit, said rear R-channel speaker unit, and said rear center speaker unit.

2. A speaker system according to claim 1 wherein said front center speaker is positioned higher than the front L-channel speaker and said front R-channel speaker.

3. A speaker system according to claim 1 wherein:
said front-center speaker faces a listener; and
vibration axes of said front L-channel speaker and said front R-channel speaker are oriented in a direction opposite that of said front-center speaker, whereby said vibration axes extend at predetermined angles toward a wall behind said front-center speaker, and in front of said listener.

4. A speaker system according to claim 1 further comprising:
said subwoofer outputs low-range components of a sum of said front L-channel signal, said front R-channel signal, said front center channel signal, said rear L-channel signal, and said rear R-channel signal.

5. A speaker system for outputting at least a front L-channel signal, a front R-channel signal, a front center-channel signal, a rear L-channel signal, and a rear R-channel signal, comprising:
one front enclosure equipped with speaker units for outputting signals processed using front channel signals; and
one rear enclosure equipped with speaker units for outputting signals processed using rear channel signals.

6. A speaker system according to claim 5 wherein said front enclosure is placed in front of a listener and said rear enclosure is placed behind said listener.

7. A speaker system according to claim 6 wherein said front enclosure is placed at a position to the front and center of said listener and said rear enclosure is placed facing said front enclosure and at a position to the rear and center of said listener.

8. A speaker system according to claim 1, wherein said front speaker unit receives at least some components of said front L-channel and said front R-channel added thereto.

9. A speaker system comprising:
a front-center speaker;
means for applying at least a front-center signal to said front-center speaker;
a front L speaker;
means for applying at least portions of L−R signals to said front L speaker;
a front R speaker;
means for applying at least portions of R−L signals to said front R speaker;
a rear-center speaker;
means for applying rear L+R signals to said rear-center speaker;
a rear L speaker;
means for applying at least portions of said rear L−R signals to said rear L speaker;
a rear R speaker; and
means for applying at least portions of said R−L signals to said rear R speaker.

10. A speaker system according to claim 9, wherein said front-center speaker is disposed at a different height from said front L speaker and said front R speaker.

11. A speaker system according to claim 9, wherein:
said front-center speaker faces a listener;
said front R speaker faces rearward diagonally rightward toward a wall; and
said front L speaker faces rearward diagonally leftward toward said wall.

12. A speaker system according to claim 9, further comprising:
a front speaker enclosure;
said front-center speaker, said front L speaker and said front R speaker are disposed in said front speaker enclosure;
a rear speaker enclosure; and
said rear-center speaker, said rear L speaker and said rear R speaker are disposed in said rear speaker enclosure, whereby only two speaker enclosures are required.

13. A speaker system according to claim 9, wherein said front L+R signal and said rear L+R signal contain only frequency components below a predetermined value.

14. A speaker system according to claim 13, wherein said predetermined value is about 2 kHz.

15. A speaker system according to claim 9, wherein said front center-channel signal includes at least components of said front L+R signals added thereto.

16. A speaker system according to claim 9, wherein said L-channel signal and said R-channel signal are added to said front center-channel signal.
